(19) United States
(12) Patent Application Publication
(10) Pub. No.: US 2026/0055259 A1
(43) Pub. Date: Feb. 26, 2026

(54) SYSTEMS AND METHODS FOR DIRECTED ASSEMBLY OF h-BN FLAKE-POLYMER MATRIX COMPOSITE FOR HIGHLY DIRECTIONAL QUANTUM SENSORS

(71) Applicant: Toyota Motor Engineering & Manufacturing North America, Inc., Plano, TX (US)

(72) Inventors: Songtao Wu, Ann Arbor, MI (US); Ercan M. Dede, Ann Arbor, MI (US); Naveed Hussain, Ypsilanti, MI (US); Paul D. Schmalenberg, Ann Arbor, MI (US); Shahriar Esmaeili, Ann Arbor, MI (US); Shougo Higashi, Ann Arbor, MI (US); Debasish Banerjee, Ypsilanti, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/814,010

(22) Filed: Aug. 23, 2024

(51) Int. Cl. C08K 3/38; C08K 3/08

(52) U.S. Cl. CPC C08K 3/38; C08K 3/08; C08K 2003/0856; C08K 2003/385; C08K 2201/01

(57) ABSTRACT

A method, computer program product, and composite patch includes attaching at least a portion of 2D-material flakes to at least a portion of ferromagnetic materials to form heterostructures. The heterostructures may be dispersed in a solvent at a first temperature. The solvent and the heterostructures may be integrated into a polymer matrix composite patch. At a second temperature below T_{c}, at least the portion of the 2D-material flakes may be adjusted within the composite patch. A polymer matrix of the polymer matrix composite patch may be cured to fix the alignment of at least the portion of the 2D-material flakes in the composite patch at a third temperature below T_{c}, wherein the composite patch, once cured, operates at fourth temperatures above T_{c}.

### BACKGROUND

Hexagonal Boron Nitride (h-BN) is an example 2D-material that may host quantum boron vacancy (V_{B}⁻) defects. These defects may be utilized as, e.g., quantum magnetometers via optical detection of magnetic resonance (ODMR). Generally, for the device to function properly, optical excitation may be performed in conjunction with microwave excitation, and microwave excitation may be used to create transitions in the quantum levels of the V_{B}⁻ defects.

### BRIEF SUMMARY OF DISCLOSURE

In one example implementation, a method may include but is not limited to attaching at least a portion of 2D-material flakes to at least a portion of ferromagnetic materials to form heterostructures. The heterostructures may be dispersed in a solvent at a first temperature. The solvent and the heterostructures may be integrated into a polymer matrix composite patch. At a second temperature below T_{c}, at least the portion of the 2D-material flakes may be adjusted within the composite patch. A polymer matrix of the polymer matrix composite patch may be cured to fix (e.g., permanently fix) the alignment of at least the portion of the 2D-material flakes in the composite patch at a third temperature below T_{c}, wherein the composite patch, once cured, operates at fourth temperatures above T_{c}.

One or more of the following example features may be included. At least the portion of the 2D-material flakes may be attached to at least the portion of the ferromagnetic material using a van der Waals force. At least the portion of the 2D-material flakes may be attached to at least the portion of the ferromagnetic material using a covalent bond. At least the portion of the 2D-material may include hexagonal boron nitride (h-BN) hosting quantum boron vacancy (V_{B}⁻) defects. The plurality of ferromagnetic material may include, at least in part, FeₓGe_{y}Te_{z}. The composite patch may be cooled below a Curie temperature of the plurality of ferromagnetic material prior to adjusting alignment of at least the portion of the 2D-material flakes in the composite patch. Functional grading of at least the portion of the 2D-material flakes alignment may be done using a designed magnetic field.

In another example implementation, a computer program product may reside on a computer readable storage medium having a plurality of instructions stored thereon which, when executed across one or more processors, may cause at least a portion of the one or more processors to perform operations that may include but are not limited to attaching at least a portion of 2D-material flakes to at least a portion of ferromagnetic materials to form heterostructures. The heterostructures may be dispersed in a solvent at a first temperature. The solvent and the heterostructures may be integrated into a polymer matrix composite patch. At a second temperature below T_{c}, at least the portion of the 2D-material flakes may be adjusted within the composite patch. A polymer matrix of the polymer matrix composite patch may be cured to fix the alignment of at least the portion of the 2D-material flakes in the composite patch at a third temperature below T_{c}, wherein the composite patch, once cured, operates at fourth temperatures above T_{c}.

One or more of the following example features may be included. At least the portion of the 2D-material flakes may be attached to at least the portion of the ferromagnetic material using a van der Waals force. At least the portion of the 2D-material flakes may be attached to at least the portion of the ferromagnetic material using a covalent bond. At least the portion of the 2D-material may include hexagonal boron nitride (h-BN) hosting quantum boron vacancy (V_{B}⁻) defects. The plurality of ferromagnetic material may include, at least in part, FeₓGe_{y}Te_{z}. The composite patch may be cooled below a Curie temperature of the plurality of ferromagnetic material prior to adjusting alignment of at least the portion of the 2D-material flakes in the composite patch. Functional grading of at least the portion of the 2D-material flakes alignment may be done using a designed magnetic field.

In another example implementation, a sensor chip may include but is not limited to a plurality of 2D-material flakes and a plurality of ferromagnetic material, wherein at least a portion of the plurality 2D-material flakes may be attached to at least a portion of the plurality of ferromagnetic material creating a plurality of heterostructures, wherein alignment of at least a portion the plurality of 2D-material flakes has been adjusted in a polymer matrix using a magnetic field, and wherein the polymer matrix may be been cured while at least the portion of the plurality of 2D-material flakes is aligned to create a composite patch with the alignment of at least the portion of the plurality of 2D-material flakes locked in the composite patch.

One or more of the following example features may be included. At least the portion of the plurality of 2D-material flakes may be attached to at least the portion of the plurality of ferromagnetic material using a van der Waals force. At least the portion of the plurality of 2D-material flakes may be attached to at least the portion of the plurality of ferromagnetic material using a covalent bond. At least the portion of the plurality of 2D-material may include hexagonal boron nitride (h-BN) hosting quantum boron vacancy (V_{B-}) defects. The plurality of ferromagnetic material may include, at least in part, FeₓGe_{y}Te_{z}. The composite patch may have been cooled below a Curie temperature of the plurality of ferromagnetic material prior to adjusting alignment of at least the portion of the plurality of 2D-material flakes in the composite patch. A temperature of the composite patch may have been raised above the Cure temperature after curing the polymer matrix.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of achieving oriented hBN flakes by linking them with FGT flakes and the use of temperature-tuned magnetism according to one or more example implementations of the disclosure;

FIG. 2 are example diagrammatic views of a uniform magnetic field and a custom magnetic field according to one or more example implementations of the disclosure;

FIG. 3 is an example diagrammatic view of two example techniques for attaching h-BN flakes to FGT flakes according to one or more example implementations of the disclosure; and

FIG. 4 is an example flowchart of a fabrication process according to one or more example implementations of the disclosure.

Like reference symbols in the various drawings may indicate like elements.

### DETAILED DESCRIPTION

Hexagonal Boron Nitride (h-BN) is an example 2D-material that may host quantum boron vacancy (V_{B}⁻) defects. These defects may be utilized as quantum magnetometers via, e.g., optical detection of magnetic resonance (ODMR). Generally, for the device to function properly, optical excitation may be performed in conjunction with microwave excitation, and microwave excitation may be used to create transitions in the quantum levels of the V_{B}⁻ defects. Conventional quantum sensors, especially those using randomly oriented spin defects (qubits) in materials like h-BN and diamond, struggle with multi-directional magnetic noise that masks weak signals. Thus, the present disclosure describes a highly directional quantum sensor made from precisely aligned h-BN flake filler particles with spin-defects embedded in a flexible polymer matrix. By leveraging a heterostructure of a ferromagnetic 2D material (e.g., FeₓGe_{y}Te_{z}) with a defined curie temperature (T_{c}) and h-BN. By applying a magnetic field when the temperature is below the T_{c} of ferromagnetic material and prior to polymer solidification, the h-BN flakes may be manipulated into a desired orientation in the final matrix-particle composite. Once aligned, this directional sensitivity of the composite material acts like a filter, drastically reducing noise from irrelevant directions. This allows a sensor to focus on the specific signal of interest, leading to a dramatically improved signal-to-noise ratio and the detection of previously undetectable signals. This composite material style quantum sensor with magnetic noise resistance has the potential to reinvent quantum sensing across various fields.

As will be discussed in greater detail below, this method may utilize some particular features:

Strong Oriented Attachment: A strong attachment may be utilized between micron-sized h-BN flakes and a chosen ferromagnetic material (e.g., Fe₄GeTe₂) using linker molecules or polymer-induced assembly to create 2D vdW heterostructures. This heterostructure complex may be used for subsequent manipulation of the flakes.

Temperature-Dependent Manipulation: By exploiting the tunable magnetic properties of the ferromagnetic material (Fe₄GeTe₂ in this example), the h-BN flake alignment may be manipulated within the polymer matrix through an external magnetic field. This allows for precise control over the final material properties. Thus, the present disclosure goes beyond random flake use, and precisely aligns h-BN flakes within a polymer matrix, unlocking entirely new material functionalities for applications like spintronics, and directional sensing. As noted above, methods for incorporating 2D materials like h-BN suffer from a critical limitation: uncontrolled flake orientation. This randomness hinders the development of materials that require precise alignment to achieve desired functionalities, especially in quantum sensing applications. The present disclosure may address this example limitation by offering a transformative approach: precise control over h-BN flakes alignment within a composite patch. This unlocks several example and non-limiting advantages:

Highly Directional Quantum Sensing: Precise alignment significantly enhances sensitivity by creating highly directional spin qubits. This acts like a filter, suppressing unwanted magnetic noise and enabling the detection of previously undetectable faint signals, which is important for breakthroughs in magnon spintronics and biomedical applications.

Reduced Magnetic Noise: Related sensors using randomly oriented h-BN are plagued by magnetic noise masking weak signals. The directional sensor may overcome this by focusing on the specific direction of interest, dramatically improving the signal-to-noise ratio.

Tailored Material Functionalities: This approach goes beyond just h-BN. The ability to precisely control flake alignment opens doors for engineering entirely new functional materials with properties tailored for various applications.

In some implementations, the present disclosure may be embodied as a method, system, or computer program product, e.g., via a fabrication process, such as fabrication process 10. Accordingly, in some implementations, the present disclosure (e.g., via fabrication process 10) may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure (e.g., via fabrication process 10) may take the form of a computer program product on a computer-usable storage medium having computer-usable program code embodied in the medium. Furthermore, in some implementations, the present disclosure (e.g., via fabrication process 10) may take the form of human actions, or a combination of human, hardware/software, computer program product actions. In some implementations, the hardware/software, computer program product actions may be executed on equipment commonly used in the semiconductor industry. For example, regarding simulation of the RF (radio frequency) characteristics, a variety of RF simulation software may be used, including but not limited to COMSOL, MATlab, Altium etc. Designing of the device may be done in a variety of computer aided design (CAD) software, such as AutoCAD, solidworks, etc. For fabrication, various equipment may be involved. Some of the more important ones being physical vapor deposition systems (e.g., magnetron sputtering, e-beam evaporation, etc. to deposit the metallic or insulating layers and for ion etching), spin coaters for coating of resist layers, laser writers and UV (ultraviolet) lithography machines for the lithography steps, scanning electron microscopes/optical microscopes for imaging and characterization, etc.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electromagnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN), a wide area network (WAN), a body area network BAN), a personal area network (PAN), a metropolitan area network (MAN), etc., or the connection may be made to an external computer (for example, through the internet using an Internet Service Provider). In some implementations, electronic circuitry including, for example, programmable logic circuitry, an application specific integrated circuit (ASIC), field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (e.g., systems), methods and computer program products according to various implementations of the present disclosure. Each block in the flowchart and/or block diagrams, and combinations of blocks in the flowchart and/or block diagrams, may represent a human action, module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

### 2D-Material-Based Composite Patch:

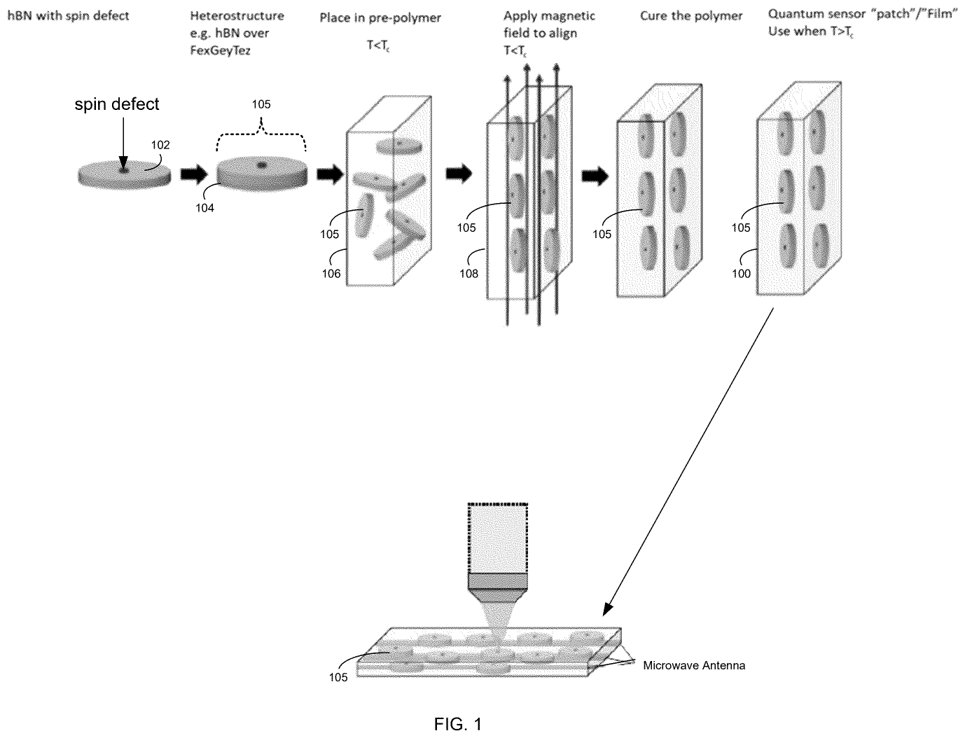

As discussed above and referring also at least to the example implementations of FIGS. 1-4, fabrication process 110 may attach 400 at least a portion of 2D-material flakes to at least a portion of ferromagnetic materials to form heterostructures. Fabrication process 110 may disperse 402 the heterostructures in a solvent at a first temperature. Fabrication process 110 may integrate 404 the solvent and the heterostructures into a polymer matrix composite patch. Fabrication process 110 may, at a second temperature below T_{c}, adjust 406 alignment of at least the portion of the 2D-material flakes within the composite patch. Fabrication process 110 may cure 412 a polymer matrix of the polymer matrix composite patch to permanently fix the alignment of at least the portion of the 2D-material flakes in the composite patch at a third temperature below T_{c}, wherein the composite patch, once cured, operates at fourth temperatures above T_{c}.

As will be described below, the present disclosure describes creating composite patches (e.g., composite patch 100 shown in example FIG. 1) with precisely aligned micron-sized 2D-material (e.g., hexagonal boron nitride (h-BN flakes) hosting quantum boron vacancy (V_{B}⁻) defects) embedded within a polymer matrix. This controlled alignment unlocks unique functionalities in the resulting material.

In some implementations, as will be discussed below and shown in the example implementation of FIG. 1, fabrication process 110 may disperse a plurality of 2D-material flakes (e.g., 2D material flakes 102) and a plurality of ferromagnetic material (e.g., ferromagnetic material 104) in a solvent. For instance, micron-sized h-BN flakes (with implanted spin-defects) and the chosen ferromagnetic material may be dispersed in a suitable solvent (e.g., solvent 106), creating a homogenous mixture.

In some implementations, fabrication process 110 may attach at least a portion of the plurality 2D-material flakes to at least a portion of the plurality of ferromagnetic material in the solvent to create a plurality of heterostructures (e.g., heterostructure(s) 105), and in some implementations, the plurality of ferromagnetic material may include, at least in part, FeₓGe_{y}Te_{z}, although it will be appreciated that any viable ferromagnetic material may be used without departing from the scope of the present disclosure. In some implementations, the 2D ferromagnetic material may be, e.g., Fe₄GeTe₂. Using this 2D ferromagnetic material may facilitate a strong and oriented attachment with the 2D h-BN flakes. This attachment may be achieved through the use of linker molecules or polymers specifically chosen for their ability to bind selectively to both h-BN and the chosen ferromagnetic material. Alternatively, polymers capable of interacting with both surfaces may be employed. This selective binding may promote a specific attachment orientation for achieving the desired material properties. Additionally, the chosen ferromagnetic material exhibits tunable magnetic properties. Thus, as will be discussed further below, by manipulating the temperature, the magnetism of the material may be controlled by decreasing the temperature lower than their curie temperature (Tc). This allows for the precise manipulation of the h-BN flakes within a polymer matrix (e.g., polymer matrix 108) to achieve a desired alignment by applying a design uniform or functionally graded external magnetic field. The polymer matrix serves as the host material, embedding the aligned h-BN flakes and the ferromagnetic material in their precisely controlled positions. This combination of chosen materials and manipulation techniques creates a platform for the development of entirely new functional materials with properties tailored for various applications.

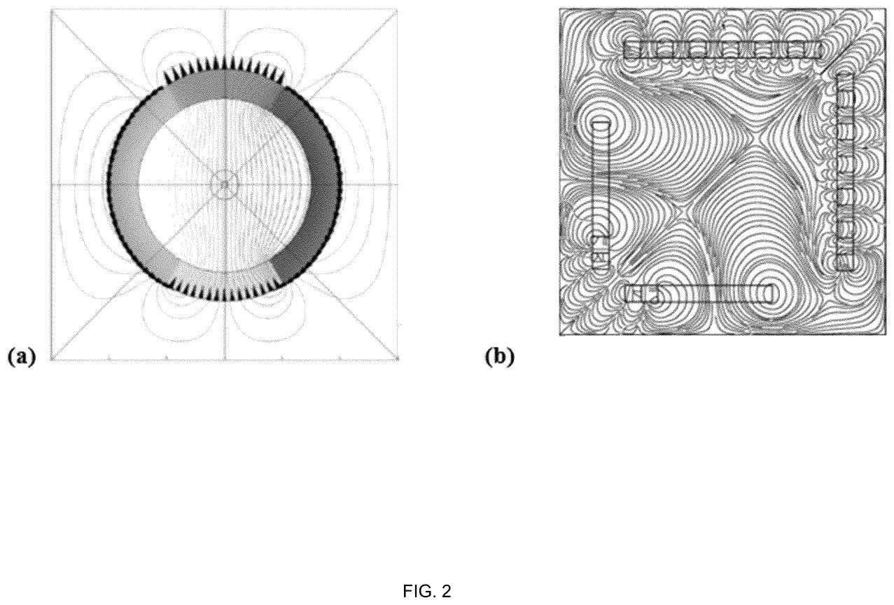

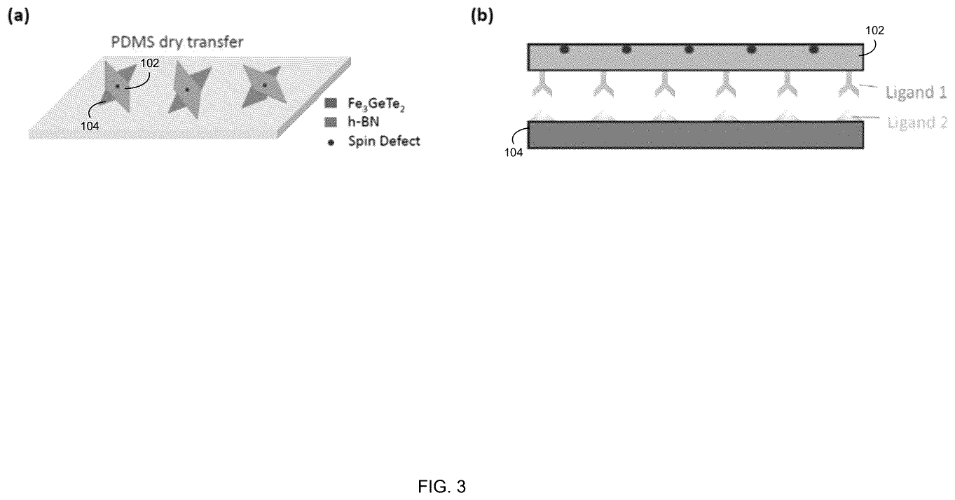

In some implementations, fabrication process 110 may incorporate the solvent into a polymer matrix to form a composite patch (e.g., composite patch 100, which may also be described as a “film”), and in some implementations, at least the portion of the plurality of 2D-material flakes may be attached to at least the portion of the plurality of ferromagnetic material using a van der Waals force (e.g., as shown in (a) in FIG. 3). For instance, a dry stamping technique with polydimethylsiloxane (PDMS) may be employed to fabricate van der Waals heterostructures comprised of hexagonal boron nitride (h-BN) and few-layered FGT (e.g., Fe₄GeTe₂). The process may begin with the independent exfoliation of FGT crystals and h-BN flakes onto separate silicon substrates coated with silicon dioxide (Si/SiO2) using the established “scotch tape” method. Subsequently, helium ion implantation may be used to introduce spin defects within the h-BN layer. Next, a PDMS stamp may be utilized to precisely transfer the exfoliated h-BN flakes and position them on top of the FGT flakes, as shown in (a) in FIG. 2. This process will be repeated to create multiple heterostructures. Finally, the fabricated heterostructures will be encapsulated within polymer matrix 108, which will be cured using, e.g., ultraviolet light to form a solid patch (e.g., composite patch 100). The final step involves peeling off the cured polymer patch containing the heterostructures from the Si/SiO2 substrates, resulting in freestanding quantum sensing patch for targeted applications.

In some implementations, at least the portion of the plurality of 2D-material flakes may be attached to at least the portion of the plurality of ferromagnetic material using a covalent bond (e.g., as shown in (b) in FIG. 3). For instance, unlike the use of van der Waals, this approach involves 2D materials with functionalized ligands, using linker molecules that are specifically chosen or designed with functional groups that can selectively bind to both h-BN and the chosen ferromagnetic material (e.g., Fe₄GeTe₂). Functional groups exhibit highly selective chemical affinities for the two materials, promoting a specific attachment orientation of two surfaces.

In some implementations, fabrication process 110 may adjust 408 alignment of the 2D-material flakes in the composite patch using a magnetic field. For instance, this step exploits a key property of the ferromagnetic material: its Curie temperature (T_{c}): The pre-polymer mixture shown in FIG. 1 is incorporated into polymer matrix 108 to form the composite patch.

In some implementations, fabrication process 110 may cool 410 the pre-polymer solution of the patch below a Curie temperature of the plurality of ferromagnetic material prior to adjusting alignment of the 2D-material flakes in the composite patch. For instance, the pre-polymer solution may be cooled below the Curie temperature (T_{c}=270 K) of the Fe₄GeTe₂. At this stage, the material gains its ferromagnetic properties. This allows for manipulation of the h-BN flakes within the polymer matrix to achieve the desired alignment by applying an external magnetic field, which aligns Fe₄GeTe₂/h-BN hybrid flakes. Uniform directional alignment of the particle (e.g., flake) may be achieved using a uniform magnetic field (e.g., for functional grading 414 of the particle orientation of a composite) realized using, e.g., a Halbach array, as shown in (b) in FIG. 2 as a top down view, for example. Alternatively, the magnetic field may be computationally designed to achieve a particular spatial distribution allowing for functional grading 414 of the particle orientation in the pre-solution of composite matrix.

In some implementations, fabrication process 110 may cure the polymer matrix to lock in the alignment of the 2D-material flakes in the composite patch. For instance, UV curing techniques may be used to lock the orientated heterostructure hybrid complexes in the polymer matrix. Finally, the temperature may be raised back to the temperature greater T_{c} (T>T_{c}) for operation, for instance, room temperature. As the temperature surpasses the Curie temperature, the ferromagnetic material loses its magnetic properties in heterostructure hybrid complexes. UV-curable polymers are favored (although not necessarily required) because they can quickly harden when exposed to ultraviolet (UV) light, bypassing the need for the high heat required in other curing methods. The polymer matrix and FeₓGe_{y}Te_{z} may be selected to ensure that the polymer's precursor remains liquid at temperatures below the Curie temperature prior to UV curing. The resulting composite patch boasts a unique structure with precisely aligned h-BN flakes embedded within the polymer matrix. This structure unlocks tailored functionalities based on the chosen materials and the achieved flake alignment for a variety of applications.

Thus, the present disclosure addresses an example limitation in 2D material utilization (the lack of control over flake orientation) by using a method for creating composite patches with precisely aligned micron-sized h-BN flakes embedded within a polymer matrix. As noted above, this may be achieved through the following features:

Oriented Attachment: vdW force attached or covalent linker molecules that promote a strong oriented attachment between h-BN flakes and a chosen ferromagnetic material (e.g., Fe₄GeTe₂). This selective binding in combination with a functionally designed magnetic field ensures the h-BN flakes are positioned in a desired orientation within the heterostructures complexes.

Tunable Magnetic Alignment: The ferromagnetic material's tunable magnetic properties are exploited. By manipulating the temperature, the magnetism can be controlled to precisely manipulate the h-BN flake alignment within the polymer matrix through the designed magnetic field before it solidifies.

### Results:

This precise control over h-BN flake alignment unlocks several example results:

Highly Directional Quantum Sensors: Precise alignment significantly enhances sensitivity by creating highly directional spin qubits. This acts like a filter, suppressing unwanted magnetic noise and enabling the detection of previously undetectable faint signals. This has significant implications for advancements in magnon spintronics and biomedical applications.

Tailored Material Functionalities: This approach goes beyond h-BN. The ability to precisely control flake alignment opens doors for engineering entirely new functional materials with properties tailored for various applications.

Overall, the present disclosure offers a transformative approach for engineering new functional materials by enabling precise control over h-BN flake alignment within a composite patch. It has the potential to revolutionize various fields that rely on high-fidelity sensing and tailored material properties. Thus, the present disclosure describes a highly directional quantum sensor made from precisely aligned h-BN flake filler particles with spin-defects embedded in a flexible polymer matrix. By leveraging a heterostructure of a ferromagnetic 2D material (e.g., FeₓGe_{y}Te_{z}) with a defined curie temperature (T_{c}) and h-BN. By applying a magnetic field when the temperature is below the T_{c} of ferromagnetic material and prior to polymer solidification, the h-BN flakes may be manipulated into a desired orientation in the final matrix-particle composite. Once aligned, this directional sensitivity of the composite material acts like a filter, drastically reducing noise from irrelevant directions. This allows a sensor to focus on the specific signal of interest, leading to a dramatically improved signal-to-noise ratio and the detection of previously undetectable signals. This composite material style quantum sensor with magnetic noise resistance has the potential to reinvent quantum sensing across various fields.

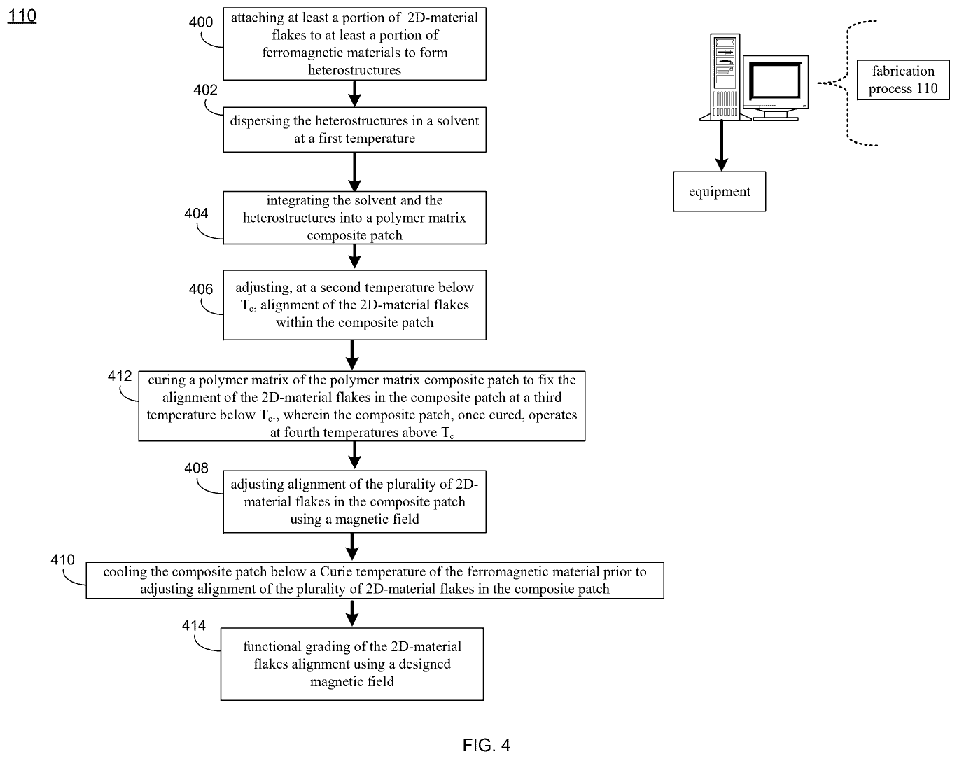

It will be appreciated after reading the present disclosure that any standard PCB assembly/printing/fabrication, etc. equipment, as well as any other necessary equipment, and any particular location, such as at a foundry, fabrication facility, etc. may be used singly or in any combination with fabrication process 110, which may be operatively connected to a computing device, such as the computing device shown in FIG. 4, to obtain their instructions for creating and/or executing one or more aspects of the present disclosure. In one or more example implementations, the respective flowcharts may be manually implemented, computer-implemented, or a combination thereof.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A and B” (and the like) as well as “at least one of A or B” (and the like) should be interpreted as covering only A, only B, or both A and B, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A method for manufacturing a composite patch, comprising:
attaching at least a portion of 2D-material flakes to at least a portion of ferromagnetic materials to form heterostructures;
dispersing the heterostructures in a solvent at a first temperature;
integrating the solvent and the heterostructures into a polymer matrix composite patch;
adjusting, at a second temperature below a Curie temperature T_{c}, alignment of at least the portion of the 2D-material flakes within the composite patch; and
curing a polymer matrix of the polymer matrix composite patch to fix the alignment of at least the portion of the 2D-material flakes in the composite patch at a third temperature below T_{c}, wherein the composite patch, once cured, operates at fourth temperatures above T_{c}.

2. The method of claim 1, wherein at least the portion of the 2D-material flakes is attached to at least the portion of the ferromagnetic material using a van der Waals force.

3. The method of claim 1, wherein at least the portion of the 2D-material flakes is attached to at least the portion of the ferromagnetic material using a covalent bond.

4. The method of claim 1, wherein at least the portion of the 2D-material includes hexagonal boron nitride (h-BN) hosting quantum boron vacancy (V_{B-}) defects.

5. The method of claim 1, wherein the plurality of ferromagnetic material includes, at least in part, FeₓGe_{y}Te_{z}.

6. The method of claim 1 further comprising cooling the composite patch below the Curie temperature of the plurality of ferromagnetic material prior to adjusting alignment of at least the portion of the 2D-material flakes in the composite patch.

7. The method of claim 1 further comprising functional grading of at least the portion of the 2D-material flakes alignment using a designed magnetic field.

8. A computer program product residing on a computer readable storage medium having a plurality of instructions stored thereon which, when executed across one or more processors, causes at least a portion of the one or more processors to perform operations comprising:
attaching at least a portion of 2D-material flakes to at least a portion of ferromagnetic materials to form heterostructures;
dispersing the heterostructures in a solvent at a first temperature;
integrating the solvent and the heterostructures into a polymer matrix composite patch;
adjusting, at a second temperature below a Curie temperature T_{c}, alignment of at least the portion of the 2D-material flakes within the composite patch; and
curing a polymer matrix of the polymer matrix composite patch to fix the alignment of at least the portion of the 2D-material flakes in the composite patch at a third temperature below T_{c}, wherein the composite patch, once cured, operates at fourth temperatures above T_{c}.

9. The computer program product of claim 8, wherein at least the portion of the 2D-material flakes is attached to at least the portion of the ferromagnetic material using a van der Waals force.

10. The computer program product of claim 8, wherein at least the portion of the 2D-material flakes is attached to at least the portion of the ferromagnetic material using a covalent bond.

11. The computer program product of claim 8, wherein at least the portion of the 2D-material includes hexagonal boron nitride (h-BN) hosting quantum boron vacancy (V_{B-}) defects.

12. The computer program product of claim 8, wherein the plurality of ferromagnetic material includes, at least in part, FeₓGe_{y}Te_{z}.

13. The computer program product of claim 8, wherein the operations further comprise cooling the composite patch below the Curie temperature of the plurality of ferromagnetic material prior to adjusting alignment of at least the portion of the 2D-material flakes in the composite patch.

14. The computer program product of claim 13, wherein the operations further comprise functional grading of at least the portion of the 2D-material flakes alignment using a designed magnetic field.

15. A composite patch comprising:
a plurality of 2D-material flakes and a plurality of ferromagnetic material,
wherein at least a portion of the plurality 2D-material flakes are attached to at least a portion of the plurality of ferromagnetic material creating a plurality of heterostructures; and
wherein alignment of the plurality of at least a portion of the plurality of 2D-material flakes has been adjusted in a polymer matrix using a magnetic field, and wherein the polymer matrix has been cured while the at least the portion of the plurality of 2D-material flakes is aligned to create a composite patch with the alignment of the at least the portion of the plurality of 2D-material flakes locked in the composite patch.

16. The composite patch of claim 15, wherein at least the portion of the plurality of 2D-material flakes is attached to at least the portion of the plurality of ferromagnetic material using one of a van der Waals force and a covalent bond.

17. The composite patch of claim 15, wherein at least the portion of the plurality of 2D-material flakes includes hexagonal boron nitride (h-BN) hosting quantum boron vacancy (V_{B-}) defects.

18. The composite patch of claim 15, wherein the plurality of ferromagnetic material includes, at least in part, FeₓGe_{y}Te_{z}.

19. The composite patch of claim 15, wherein the composite patch has been cooled below a Curie temperature of the plurality of ferromagnetic material prior to adjusting alignment of at least the portion of the plurality of 2D-material flakes in the composite patch.

20. The composite patch of claim 19, wherein a designed magnetic field is used for functional grading of at least the portion of the plurality of 2D-material flakes alignment.
